(19) United States
(12) Patent Application Publication
(10) Pub. No.: US 2026/0004748 A1
(43) Pub. Date: Jan. 1, 2026

(54) DISPLAY DEVICE, METHOD OF COMPENSATING FOR LUMINANCE AND COLOR OF THE DISPLAY DEVICE, AND ELECTRONIC DEVICE INCLUDING THE DISPLAY DEVICE

(71) Applicant: Samsung Display Co., Ltd., Yongin-Si (KR)

(72) Inventors: MINGYU KIM, Yongin-si (KR); HYUNGWOO YIM, Yongin-si (KR); JAE-SEOB CHUNG, Yongin-si (KR); SEYUN KIM, Yongin-si (KR); SEUNGHO PARK, Yongin-si (KR)

(21) Appl. No.: 19/075,783

(22) Filed: Mar. 11, 2025

(30) Foreign Application Priority Data
Jul. 1, 2024 (KR) 10-2024-0086046

(51) Int. Cl. G09G 3/34

(52) U.S. Cl. CPC G09G 3/3413; G09G 2310/0275; G09G 2320/0233; G09G 2320/0242; G09G 2320/0276; G09G 2330/028

(57) ABSTRACT

A display device comprises a display panel including a plurality of compensation areas, each of which includes at least one pixel, a driving controller including a compensation controller and a luminance color compensator, performing a luminance and color compensation for each of the compensation areas, and generating a voltage code and a data signal, a gamma reference voltage generator receiving the voltage code and generating a gamma reference voltage based on the voltage code, and a data driver connected to the driving controller and the gamma reference voltage generator and generating a data voltage based on the data signal and the gamma reference voltage. Each of the compensation areas after the luminance and color compensation may have a target gamma value and a target color coordinate. The compensation areas may be shifted while the luminance color compensation is performed.

### CROSS-REFERENCE TO RELATED APPLICATION(S)

This application claims priority under 35 USC § 119 to Korean Patent Application No. 10-2024-0086046 filed on Jul. 1, 2024 in the Korean Intellectual Property Office (KIPO), the entire disclosure of which is incorporated by reference herein.

### BACKGROUND

### 1. Field

Embodiments of the present disclosure relate to a display device, a method of compensating for a luminance and a color of the display device, and an electronic device including the display device. More particularly, the present disclosure relates to a display device which performs a luminance and color compensation, a method of compensating for a luminance and a color of the display device, and an electronic device including the display device performing the luminance and color compensation.

### 2. Description of the Related Art

A display device may include a display panel, and the display panel may include a plurality of pixels which may emit a light. However, the pixels may have different luminance and color coordinates due to deviations in a manufacturing process, etc. A post-processing may be performed on the pixels to improve a luminance uniformity and a color coordinate uniformity of the pixels. For example, a Luminance and Color Compensation (LCC) may be performed to ensure that the pixels have a target gamma value and a target color coordinate.

### SUMMARY

Embodiments of the present disclosure provide a display device performing a luminance and color compensation to improve a display quality.

Embodiments of the present disclosure provide a method of compensating for a luminance and a color of the display device.

Embodiments of the present disclosure provide an electronic device including the display device performing the luminance and color compensation.

According to an embodiment of the present disclosure, a display device comprises a display panel including a plurality of compensation areas, each of which includes at least one pixel, a driving controller including a compensation controller and a luminance color compensator, performing a luminance and color compensation for the each of the compensation areas, and generating a voltage code and a data signal, a gamma reference voltage generator receiving the voltage code and generating a gamma reference voltage based on the voltage code, and a data driver connected to the driving controller and the gamma reference voltage generator, and generating a data voltage based on the data signal and the gamma reference voltage. Each of the compensation areas after the luminance and color compensation may have a target gamma value and a target color coordinate. The compensation areas may be shifted while the luminance color compensation is performed.

In an embodiment, a luminance difference corresponding to a delta voltage code may occur at a compensation boundary when the luminance color compensation is performed.

In an embodiment, the luminance difference corresponding to the delta voltage code may become large when the delta voltage code is large.

In an embodiment, the voltage code may change when the compensation areas are shifted while the luminance color compensation is performed.

In an embodiment, a degree to which the voltage code changes may vary depending on a shift degree of the compensation areas.

In an embodiment, the voltage code may change gradually when the shift degree of the compensation areas is large.

In an embodiment, the voltage code in an area between two adjacent compensation areas may be sequentially changed by the delta voltage code.

In an embodiment, a shift direction of the compensation areas may be a left-right direction.

In an embodiment, a shift direction of the compensation areas may be an up-down direction.

In an embodiment, a shift degree of the compensation areas may vary depending on a resolution of the display panel.

In an embodiment, the shift degree of the compensation areas may become great when the resolution of the display panel is high.

According to an embodiment of the present disclosure, a method of compensating for a luminance and a color of a display device comprises performing a luminance and color compensation for each of a plurality of compensation areas included in a display panel, generating a voltage code and a data signal, generating a gamma reference voltage based on the voltage code, and generating a data voltage based on the data signal and the gamma reference voltage. Each of the compensation areas after the luminance and color compensation may have a target gamma value and a target color coordinate. The compensation areas may be shifted while the luminance and color compensation is performed.

In an embodiment, a luminance difference corresponding to a delta voltage code may occur at a compensation boundary when the luminance color compensation is performed.

In an embodiment, the luminance difference corresponding to the delta voltage code may become large when the delta voltage code is large.

In an embodiment, the voltage code may change when the compensation areas are shifted while the luminance color compensation is performed.

In an embodiment, a degree to which the voltage code changes may vary depending on a shift degree of the compensation areas.

In an embodiment, the voltage code may change gradually when the shift degree of the compensation areas is large.

In an embodiment, the voltage code in an area between two adjacent compensation areas may be sequentially changed by the delta voltage code.

In an embodiment, a shift direction of the compensation areas may be a left-right direction.

According to an embodiment of the present disclosure, an electronic device comprises a display panel including a plurality of compensation areas, each of which includes at least one pixel, a driving controller including a compensation controller and a luminance color compensator, performing a luminance color compensation for the each of the compensation areas, and generating a voltage code and a data signal, a processor configured to control the driving controller, a gamma reference voltage generator receiving the voltage code and generating a gamma reference voltage based on the voltage code, and a data driver connected to the driving controller and the gamma reference voltage generator, and generating a data voltage based on the data signal and the gamma reference voltage. Each of the compensation areas after the luminance and color compensation may have a target gamma value and a target color coordinate. The compensation areas may be shifted while the luminance color compensation is performed.

According to the display device, the method of compensating for the luminance and the color of the display device, and the electronic device including the display device, the luminance difference corresponding to the delta voltage code may be prevented from being perceived by shifting the compensation areas during the luminance and color compensation.

### BRIEF DESCRIPTION OF THE DRAWINGS

The above and other features of embodiments of the present disclosure will become more apparent with reference to the description below and the accompanying drawings.

FIG. 1 is a block diagram showing a display device according to an embodiment of the present disclosure.

FIG. 2 is a circuit diagram showing a pixel of FIG. 1.

FIG. 3 is a drawing showing sub-pixels included in a pixel of FIG. 1.

FIG. 4 is a diagram showing an operation in which a luminance of a display panel is measured by a luminance measuring device to perform luminance and color compensation.

FIG. 5 is a block diagram showing a driving controller of FIG. 1, which performs a luminance and color compensation, as well as a gamma reference voltage generator and a data driver of FIG. 1, which operate based on the luminance and color compensation.

FIG. 6 is a diagram illustrating a voltage code according to a position.

FIG. 7 is a diagram showing a luminance and color compensation according to an embodiment of the present disclosure.

FIG. 8 is a diagram showing a voltage code according to a position based on the luminance and color compensation of FIG. 7.

FIG. 9 is a diagram showing an operation in which a luminance of a display panel having a stain on the display panel is measured by a luminance measuring device.

FIG. 10 is a diagram showing a luminance of a display panel of FIG. 9 when a luminance and color compensation according to an embodiment of the present disclosure is not performed.

FIG. 11 is a diagram showing a luminance of a first color and a voltage code for the first color with respect to a luminance of a display panel of FIG. 10.

FIG. 12 is a diagram showing a luminance of a second color and a voltage code for a second color with respect to a luminance of a display panel of FIG. 10.

FIG. 13 is a diagram showing a luminance of a third color and a voltage code for a third color with respect to a luminance of a display panel of FIG. 10.

FIG. 14 and FIG. 15 are diagrams showing a luminance of a display panel of FIG. 10 when a shift of a compensation area is performed during a luminance and color compensation according to an embodiment of the present disclosure.

FIG. 16 is a block diagram showing an electronic device.

FIG. 17 is a diagram showing an example in which an electronic device of FIG. 16 is implemented as a smart phone.

### DETAILED DESCRIPTION OF THE EMBODIMENTS

Hereinafter, a display device performing a luminance and color compensation, a method of compensating for a luminance and a color of the display device, and an electronic device including the display device according to the present disclosure will be described in more detail with reference to the accompanying drawings.

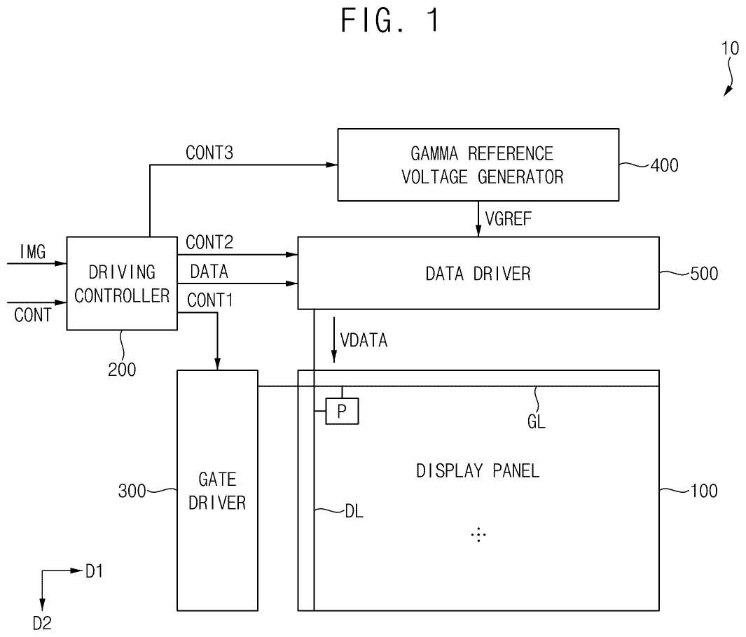

FIG. 1 is a block diagram showing a display device 10 according to an embodiment of the present disclosure.

Referring to FIG. 1, a display device 10 may include a display panel 100 and a display panel driver. The display panel driver may include a driving controller 200, a gate driver 300, a gamma reference voltage generator 400, and a data driver 500.

The display panel 100 may include a display area for displaying an image and a peripheral area arranged adjacent to the display area.

The display panel 100 may include gate lines GL, data lines DL, and pixels electrically connected to the gate lines GL and the data lines DL, respectively. The gate lines GL may extend in a first direction, and the data lines DL may extend in a second direction crossing the first direction.

The driving controller 200 may receive input image data IMG and an input control signal CONT from an external device. For example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The gate driver 300 may generate gate signals for driving a pixel PX in response to the first control signal CONT1 received from the driving controller 200. The gate driver 300 may output the gate signals to the gate lines GL to be transmitted to the pixel PX.

In an embodiment, the gate driver 300 may be integrated on the peripheral area of the display panel 100.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to each data signal DATA.

For example, the gamma reference voltage generator 400 may be arranged in the driving controller 200 or may be arranged in the data driver 500.

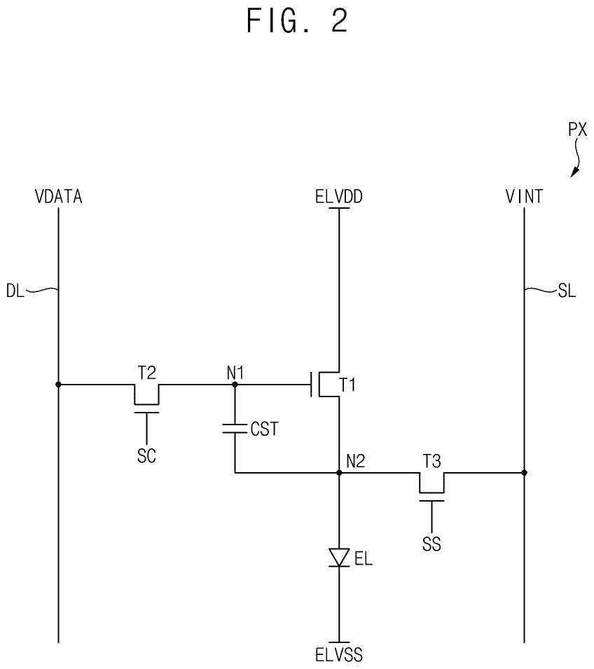

The data driver 500 may receive the second control signal CONT2 and the data signal DATA from the driving controller 200, and receive the gamma reference voltage VGREF from the gamma reference voltage generator 400. The data driver 500 may convert the data signal DATA into a data voltage having an analog type using the gamma reference voltage VGREF. The data driver 500 may output the data voltage to the data line DL. FIG. 2 is a circuit diagram showing a pixel PX of FIG. 1.

Referring to FIG. 2, a pixel PX may include a first transistor T1, a second transistor T2, a third transistor T3, and a storage capacitor CST. In an embodiment, the first transistor T1, the second transistor T2, and the third transistor T3 may be N-type transistors.

The first transistor T1 may include a gate electrode connected to a first node N1, a first electrode connected to a first power voltage line transmitting a first power voltage ELVDD, and a second electrode connected to a second node N2. The first transistor T1 may generate a driving current based on a voltage of the first node N1 and a voltage of the second node N2.

The second transistor T2 may include a gate electrode receiving a scan signal SC as a gate signal, a first electrode connected to a data line DL transmitting a data voltage VDATA, and a second electrode connected to the first node N1. The second transistor T2 may be turned on in response to the scan signal SC to provide the data voltage VDATA to the first node N1. The data voltage VDATA may vary based on a grayscale. For example, the grayscale may be 1-grayscale to 256-grayscale, and as the grayscale increases, the data voltage VDATA may increase.

The third transistor T3 may include a gate electrode receiving a sensing signal SS as a gate signal, a first electrode connected to a sensing line SL transmitting an initialization voltage VINT, and a second electrode connected to the second node N2. The third transistor T3 may be turned on in response to the sensing signal SS to provide the initialization voltage VINT to the second node N2. When the third transistor T3 is turned on, the second node N2 may be initialized with the initialization voltage VINT.

The storage capacitor CST may include a first electrode connected to the first node N1 and a second electrode connected to the second node N2. The storage capacitor CST may store a voltage corresponding to the data voltage VDATA between two electrodes of the storage capacitor CST. Therefore, the first transistor T1 may generate the driving current based on the voltage corresponding to the data voltage VDATA stored in the storage capacitor CST.

The light emitting element EL may include an anode connected to the second node N2 and a cathode connected to a second power voltage line transmitting a second power voltage ELVSS. The light emitting element EL may emit a light based on the driving current. A luminance represented by the light emitting element EL may be determined based on an intensity of the driving current. The intensity of the driving current may be determined based on the data voltage VDATA.

FIG. 2 shows a pixel including three transistors and one capacitor, but the present disclosure is not limited thereto.

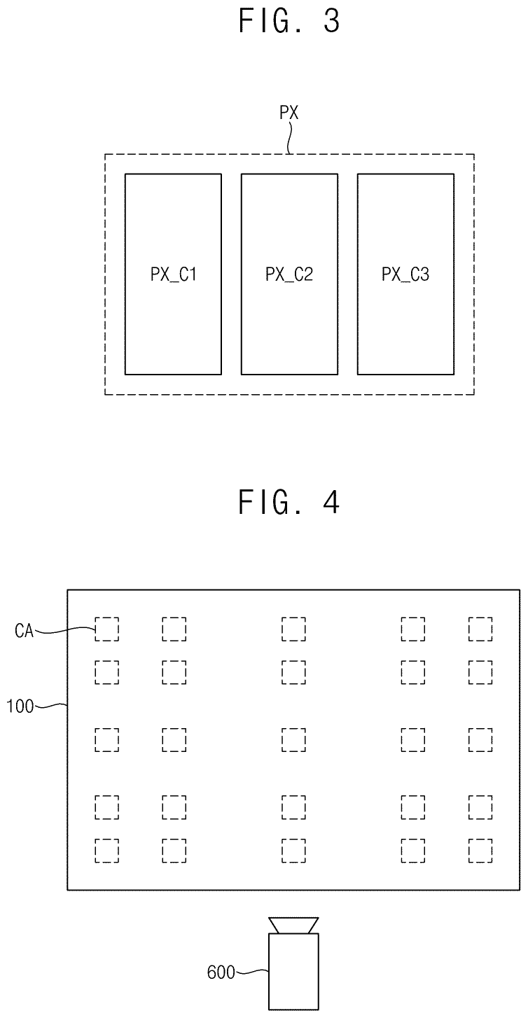

FIG. 3 is a drawing showing sub-pixels included in a pixel PX of FIG. 1.

Referring to FIG. 3, a pixel PX may include sub-pixels PX_C1, PX_C2, PX_C3. In an embodiment, the sub-pixels PX_C1, PX_C2, PX_C3 may include a first color sub-pixel PX_C1 emitting light of a first color, a second color sub-pixel PX_C2 emitting light of a second color, and a third color sub-pixel PX_C3 emitting light of a third color. The first color, the second color, and the third color may be different from each other. For example, the first color may be a red, the second color may be a green, and the third color may be a blue.

FIG. 3 shows a pixel including three sub-pixels PX_C1, PX_C2 and PX_C3 representing three colors, but the present disclosure is not limited thereto.

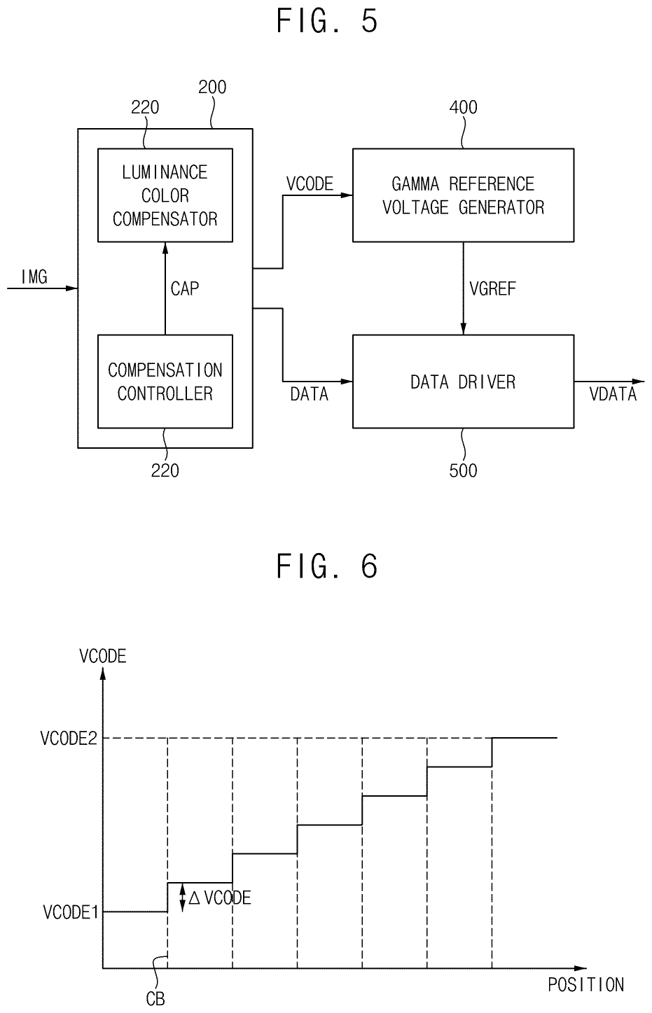

FIG. 4 is a diagram showing an operation in which a luminance of a display panel 100 is measured by a luminance measuring device 600 to perform luminance and color compensation. FIG. 5 is a block diagram showing a driving controller 200 of FIG. 1, which performs a luminance and color compensation, as well as a gamma reference voltage generator 400 and a data driver 500 of FIG. 1, which operate based on the luminance and color compensation. FIG. 6 is a diagram illustrating a voltage code VCODE according to a position.

Referring to FIG. 4, a display panel 100 may include a plurality of pixels PX, and the pixels PX may emit a light. However, the pixels PX may have different luminance and color coordinates due to deviations in a manufacturing process, etc. In order to improve a luminance uniformity and a color coordinate uniformity of the pixels PX, a LCC (Luminance Color Compensation) may be performed, such that the pixels PX have a target gamma value and a target color coordinate.

The optical compensation device performing the luminance and color compensation may include a display device 10 including the display panel 100, and a luminance measuring device 600. The display panel 100 including the pixels PX may be divided into a plurality of compensation areas CA. Each of the compensation areas CA may include at least one pixel PX. The luminance measuring device 600 may measure a luminance of the each of the compensation areas CA.

Referring to FIG. 5, the display device 10 may include a driving controller 200, a gamma reference voltage generator 400, and a data driver 500. The driving controller 200 may receive input image data IMG, and may perform a luminance and color compensation based on the input image data IMG to generate a voltage code VCODE and a data signal DATA. The gamma reference voltage generator 400 may generate a gamma reference voltage VREF based on the voltage code VCODE. The data driver 500 may generate a data voltage VDATA based on the gamma reference voltage VREF and the data signal DATA.

The driving controller 200 may include a compensation controller 210 and a luminance color compensator 220.

The compensation controller 210 may control the luminance color compensator 220 performing the luminance and color compensation. In an embodiment, the compensation controller 210 may provide the luminance color compensator 220 with a compensation area position signal CAP, which includes an information about positions of the compensation areas CA on which the luminance and color compensation is to be performed. Here, the compensation controller 210 may be a MCU (Micro Controller Unit).

The luminance color compensator 220 may receive input image data IMG and the compensation area position signal CAP, and may perform the luminance and color compensation. Specifically, the luminance color compensator 220 may determine the positions of the compensation areas CA on which the luminance and color compensation is performed based on the compensation area position signal CAP, and may perform the luminance and color compensation on the compensation areas CA. When the luminance and color compensation is performed on the compensation areas CA, each of the compensation areas CA may have a voltage code VCODE. Accordingly, each of the compensation areas CA may have the target gamma value and the target color coordinate.

The luminance color compensator 220 may perform the luminance and color compensation on an area of the display panel 100 excluding the compensation areas CA. Specifically, the luminance color compensator 220 may interpolate voltage codes VCODE of the compensation areas CA to obtain a voltage code VCODE for the area of the display panel 100 excluding the compensation areas CA.

Referring to FIG. 6, for example, a first compensation area may have a first voltage code VCODE1, and a second compensation area may have a second voltage code VCODE2. In order to perform the luminance and color compensation for an area between the first compensation area and the second compensation area, the luminance color compensator 220 may interpolate the first voltage code VCODE1 and the second voltage code VCODE2. Therefore, in the area between the first compensation area and the second compensation area, the voltage code VCODE may be sequentially changed by a delta voltage code ΔVCODE, which is obtained by the interpolation of the first voltage code VCODE1 and the second voltage code VCODE2. Here, a position where the voltage code VCODE is changed may be defined as a compensation boundary CB. That is, the compensation boundary CB may an area where the interpolation is performed, and an area between two compensation areas.

However, the data voltage VDATA which determines a luminance of the pixels PX may be determined based on the gamma reference voltage VGREF, and the gamma reference voltage VGREF may be determined based on the voltage code VCODE. Therefore, at the compensation boundary CB, a luminance difference corresponding to the delta voltage code ΔVCODE may occur. The more rapidly the voltage code VCODE changes, the more likely the luminance difference may be perceived by a user. For example, the larger the delta voltage code ΔVCODE, the greater the luminance difference may be. Thus, the luminance difference may become perceivable to the user, and a display quality may deteriorate. For example, the more the luminance difference corresponding to the delta voltage code ΔVCODE changes in a smaller area, the more the luminance difference may be perceived by the user, potentially leading to deterioration of the display quality.

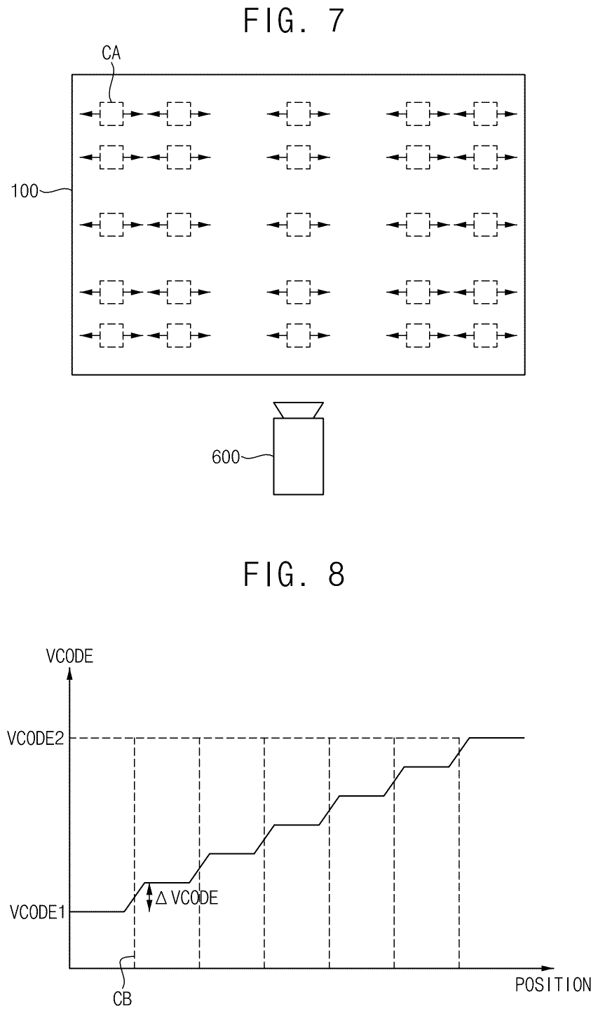

FIG. 7 is a diagram showing a luminance and color compensation according to an embodiment of the present disclosure. FIG. 8 is a diagram showing a voltage code VCODE according to a position based on a luminance and color compensation of FIG. 7.

Referring to FIG. 7, while a luminance and color compensation is performed, compensation areas CA may be shifted. That is, positions of the compensation areas CA may be changed. A shift direction and a shift degree of the compensation areas CA may be included in the compensation area position signal CAP, and the compensation area position signal CAP including a shift direction and a shift degree of the compensation areas CA may be provided to the luminance color compensator 220.

For example, the compensation areas CA may be shifted for each frame. However, the present disclosure is not limited thereto. The compensation areas CA may be shifted for each time period shorter than one frame or for each time period longer than one frame.

For example, as shown in FIG. 7, the compensation areas CA may be shifted left and right. For example, the compensation areas CA may be shifted up and down. However, the shift direction of the compensation areas CA is not limited thereto. The compensation areas CA may be shifted in any direction.

For example, the compensation areas CA may be shifted in units of 8 pixels. The compensation areas CA may be shifted in units of 16 pixels. However, the shift degree of the compensation areas CA is not limited thereto. When the shift degree of the compensation areas CA is great, a shift of the compensation areas CA may be perceived by the user. A shift degree at which the shift of the compensation areas CA becomes noticeable may vary depending on a resolution of the display panel 100 (i.e., a number of the pixels PX). For example, when the resolution of the display panel 100 is high, the shift degree at which the shift of the compensation areas CA becomes noticeable may also be greater. Therefore, the shift degree of the compensation areas CA may have any value within a range where the shift of the compensation areas CA remains unnoticeable.

Referring to FIG. 8, as described above, at the compensation boundary CB, a luminance difference corresponding to the delta voltage code ΔVCODE may occur. The more rapidly the voltage code VCODE changes, the more likely the luminance difference may become perceivable to the user. For example, the larger the delta voltage code ΔVCODE, the more likely the luminance difference may become perceivable to the user. For example, the smaller the area where the luminance difference corresponding to the delta voltage code ΔVCODE changes becomes, the more likely the user may perceive the luminance difference.

In order to prevent the luminance difference corresponding to the delta voltage code ΔVCODE from being noticeable to the user, the luminance and color compensation according to an embodiment of the present disclosure may change the voltage code VCODE gradually. According to an embodiment, in order to prevent the luminance difference from be perceived by the user, the delta voltage code ΔVCODE may be reduced. According to an embodiment, the compensation areas CA may be shifted. Here, reducing the delta voltage code ΔVCODE may imply increasing a resolution of the gamma reference voltage VGREF.

When the compensation areas CA are shifted, the voltage code VCODE may not change instantaneously from the delta voltage code ΔVCODE at the compensation boundary CB. When the compensation areas CA are shifted, the voltage code VCODE may change gradually in an area around the compensation boundary CB. A degree to which the voltage code VCODE changes gradually may vary depending on the shift degree of the compensation areas CA. Since an area where the voltage code VCODE changes varies depending on the shift degree of the compensation areas CA, a degree to which the voltage code VCODE changes gradually may vary depending on the shift degree of the compensation areas CA. When the shift degree of the compensation areas CA is large, the voltage code VCODE may change more gradually. For example, when the compensation areas CA are shifted in units of 16 pixels, the area where the voltage code VCODE changes may be larger. Thus, the shift degree of the compensation areas CA may be larger, and the voltage code VCODE may change more gradually compared to an example in which the compensation areas CA are shifted in units of 8 pixels. Therefore, the larger the shift degree of the compensation areas CA becomes, the less likely the luminance difference corresponding to the delta voltage code ΔVCODE may be perceivable to the user.

The shift of the compensation areas CA used in a luminance and color compensation according to an embodiment of the present disclosure should be distinguished from a general image shift.

When a same data (e.g., a fixed image such as a logo) is input to a same pixel for a long time, an afterimage may remain in an image. The general image shift is performed to prevent the afterimage from occurring in the image. For example, in the general image shift, all or part of an image corresponding to input image data IMG may be shifted to prevent the afterimage. Although the general image shift may prevent the afterimage from occurring in the image, the general image shift may not prevent the luminance difference corresponding to the delta voltage code ΔVCODE from being perceived.

In contrast, according to an embodiment, the shift of the compensation areas CA is performed to prevent the luminance difference corresponding to the delta voltage code ΔVCODE from being perceived. For example, the compensation areas CA are shifted.

As such, when the compensation areas CA are shifted while the luminance and color compensation is performed, the luminance difference corresponding to the delta voltage code ΔVCODE may be prevented from being perceived.

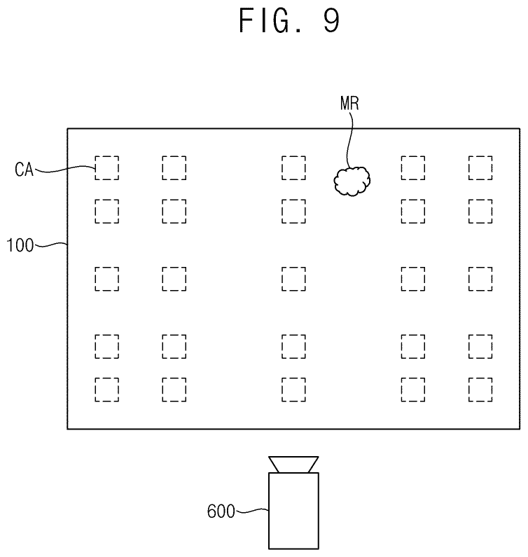

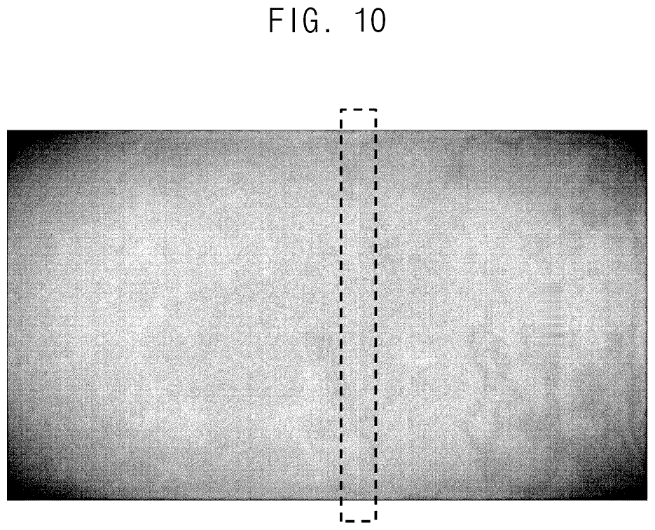

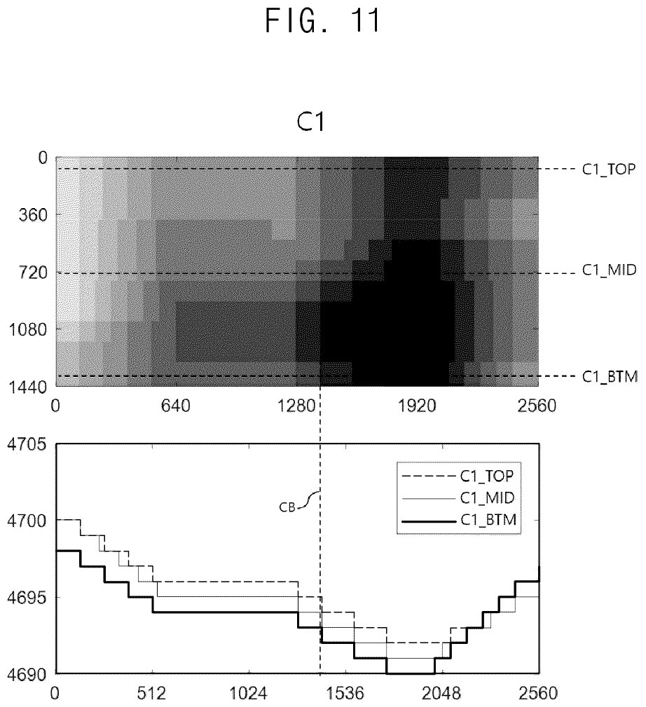

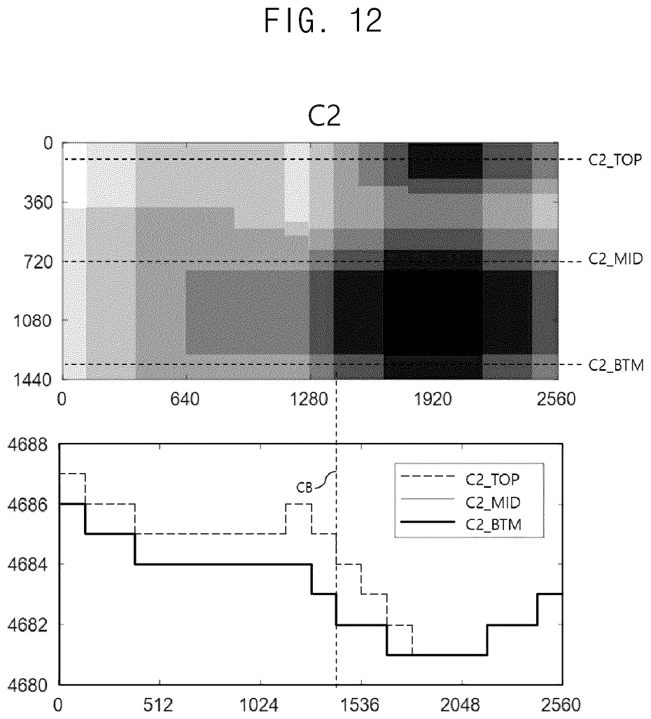

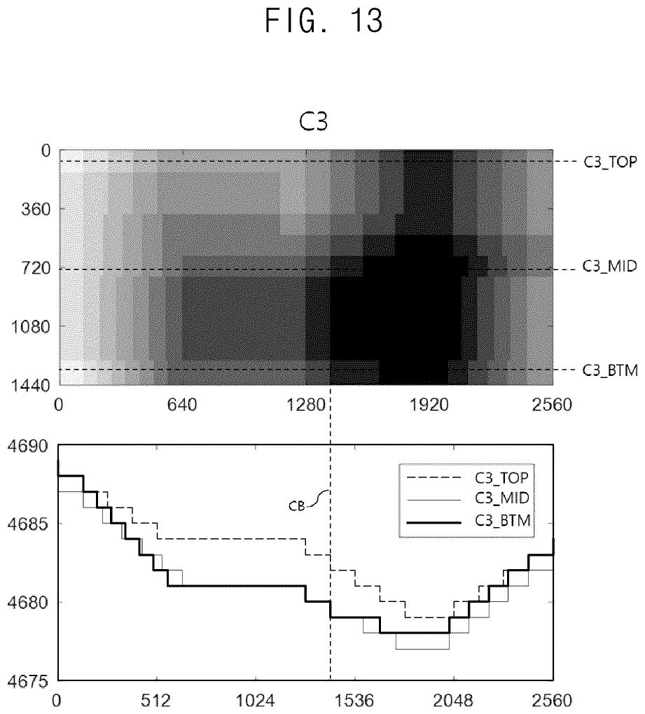

FIG. 9 is a diagram showing an operation in which a luminance of a display panel 100 having a stain on the display panel 100 is measured by a luminance measuring device 600. FIG. 10 is a diagram showing a luminance of a display panel 100 of FIG. 9 when a luminance and color compensation according to an embodiment of the present disclosure is not performed. FIG. 11 is a diagram showing a luminance of a first color C1 and a voltage code of the first color C1 with respect to a luminance of a display panel 100 of FIG. 10. FIG. 12 is a diagram showing a luminance of a second color C2 and a voltage code of a second color C2 with respect to a luminance of a display panel 100 of FIG. 10. FIG. 13 is a diagram showing a luminance of a third color C3 and a voltage code of a third color C3 with respect to a luminance of a display panel 100 of FIG. 10.

Referring to FIG. 9, a display panel 100 may include a plurality of pixels PX and may be divided into a plurality of compensation areas CA. In this example, a stain MR may exist on the display panel 100, and due to the stain MR, a luminance of the display panel 100 may increase or decrease in some area. A luminance measuring device 600 may measure a luminance of each of the compensation areas CA, and a luminance and color compensation may be performed.

Referring to FIG. 10, a vertical line may be perceived in the area where the stain MR exists on the display panel 100. The vertical line may cause a deterioration in a display quality.

Referring to FIG. 11, FIG. 11 shows a luminance of a first color C1 and voltage codes of the first color C1 corresponding to the luminance of the first color C1 at a first horizontal position C1_TOP, a second horizontal position C1_MID, and a third horizontal position C1_BTM.

For example, a resolution of a display panel 100 may be 2560×1440. That is, the display panel 100 may include 2560×1440 pixels. When a shift of compensation areas CA is not performed while a luminance and color compensation is performed, the luminance of the first color C1 may have boundaries (i.e., compensation boundaries CB).

The luminance of the first color C1 may be analyzed according to a horizontal position. For example, the horizontal position may have 0 to 2560. For example, the voltage code of the first color C1 may vary in a range from 4675 to 4690 at the first horizontal position C1_TOP, the second horizontal position C1_MID, and the third horizontal position C1_BTM.

The luminance of the first color C1 may increase or decrease at a horizontal position where the stain MR exists. The voltage code of the first color C1 may change instantaneously at a compensation boundaries CB. As such, when the stain MR exists in the compensation boundary CB and the shift of the compensation areas CA is not performed during the luminance and color compensation, the vertical lines, etc. may be perceived, thereby degrading the display quality.

Referring to FIGS. 12 and 13, FIG. 12 shows a luminance of a second color C2, and voltage codes of the second color C2 corresponding to the luminance of the second color C2 at a first horizontal position C2_TOP, a second horizontal position C2_MID, and a third horizontal position C2_BTM. FIG. 13 shows a luminance of a third color C3, and voltage codes of the third color C3 corresponding to the luminance of the third color C3 at a first horizontal position C3_TOP, a second horizontal position C3_MID, and a third horizontal position C3_BTM.

The luminance of the second color C2 may increase or decrease at the horizontal position where the stain MR exists. The voltage code of the second color C2 may change instantaneously at the compensation boundary CB. The luminance of the third color C3 may increase or decrease at the horizontal position where the stain MR exists. The voltage code of the third color C3 may change instantaneously at the compensation boundary CB. As such, when the stain MR exists at the compensation boundary CB and the shift of the compensation areas CA is not performed during the luminance and color compensation, the vertical lines, etc. may be perceived, thereby degrading the display quality.

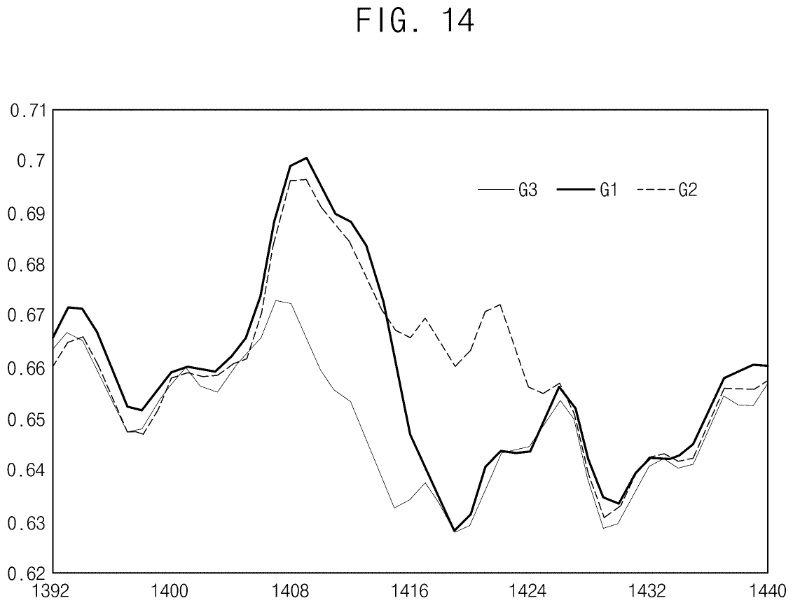

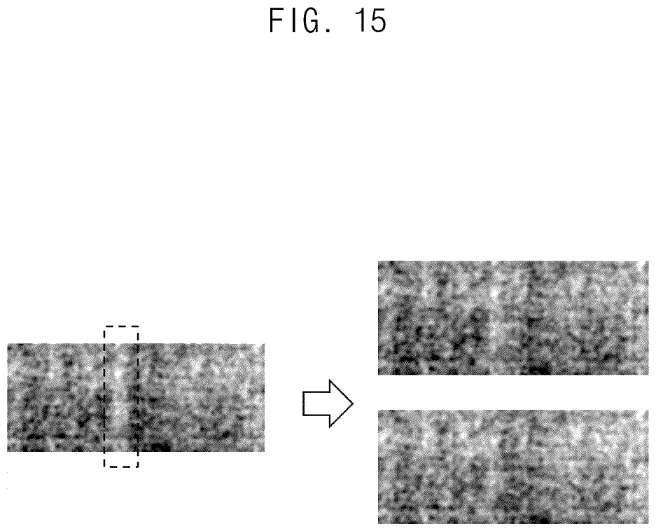

FIG. 14 and FIG. 15 are diagrams showing a luminance of a display panel 100 of FIG. 10 when a shift of a compensation areas CA is performed during a luminance and color according to an embodiment of the present disclosure.

Referring to FIG. 14, a luminance of a display panel 100 may be analyzed according to a horizontal position. For example, the display panel 100 may be analyzed at a vertical position where the luminance ranges from 1392 to 1440. A first graph G1 is a graph in which a shift of compensation areas CA is not performed during a luminance and color compensation. A second graph G2 and a third graph G3 are graphs in which the shift of the compensation areas CA is performed during the luminance and color compensation.

A luminance of the first graph G1 decreases from 0.7 to 0.63 during a first time period. A luminance of the second graph G2 decreases from 0.7 to 0.63 during a second time period which is longer than the first time period. A luminance of the third graph G3 decreases from 0.675 to 0.63 during the first time period. The luminance of the second graph G2 gradually decreases compared to the luminance of the first graph G1. A luminance difference of the third graph G3 is less than a luminance difference of the first graph G1. Therefore, a luminance difference of the second graph G2 and the luminance difference of the third graph G3 may be less perceivable to the user than the luminance difference of the first graph G1.

Referring to FIG. 15, a vertical line is highly noticeable within a dotted line box on a left. In contrast, the vertical line is not noticeable on a right.

As such, when the compensation areas CA are shifted while the luminance and color compensation is performed, the luminance difference corresponding to the delta voltage code ΔVCODE may be prevented from being perceived.

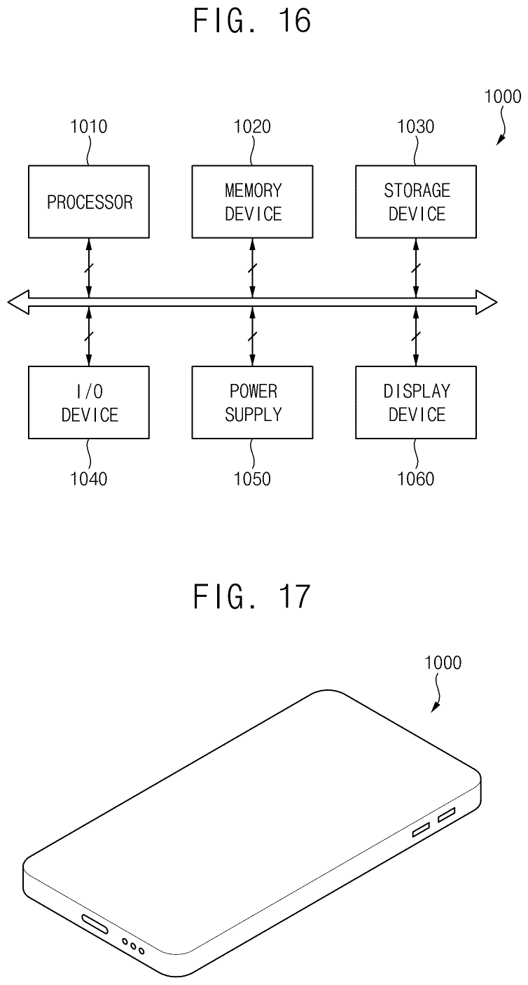

FIG. 16 is a block diagram showing an electronic device 1000. FIG. 17 is a diagram showing an example in which an electronic device 1000 of FIG. 16 is implemented as a smart phone.

Referring to FIGS. 16 and 17, an electronic device 1000 may include a processor 1010, a memory device 1020, a storage device 1030, an input/output I/O device 1040, a power supply 1050, and a display device 1060. The display device 1060 may be the display device 10 of FIG. 1. In addition, the electronic device 1000 may further include a plurality of ports for communicating with a video card, a sound card, a memory card, a universal serial bus USB device, or other electronic device.

According to an embodiment, as illustrated in FIG. 17, the electronic device 1000 may be implemented as the smart phone. However, the present disclosure is not limited thereto. For example, the electronic device 1000 may be implemented as a cellular phone, a video phone, a smart pad, a smart watch, a tablet PC, a car navigation system, a computer monitor, a laptop, a head mounted display HMD device, or the like.

The processor 1010 may perform various computing functions. The processor 1010 may be a microprocessor, a central processing unit CPU, an application processor AP, or the like. The processor 1010 may be coupled to other components via an address bus, a control bus, a data bus, or the like. Further, the processor 1010 may be coupled to an extended bus such as a peripheral component interconnection PCI bus.

The memory device 1020 may store data for operations of the electronic device 1000. For example, the memory device 1020 may include at least one nonvolatile memory device such as an erasable programmable read-only memory EPROM device, an electrically erasable programmable read-only memory EEPROM device, a flash memory device, a phase change random access memory PRAM device, a resistance random access memory RRAM device, a nano floating gate memory NFGM device, a polymer random access memory PoRAM device, a magnetic random access memory MRAM device, a ferroelectric random access memory FRAM device, or at least one volatile memory device such as a dynamic random access memory DRAM device, a static random access memory SRAM device, a mobile DRAM device, or the like.

The storage device 1030 may include a solid state drive SSD device, a hard disk drive HDD device, a CD-ROM device, or the like.

The I/O device 1040 may include an input device such as a keyboard, a keypad, a mouse device, a touch-pad, a touch-screen, or the like, and an output device such as a printer, a speaker, or the like. The I/O device 1040 may include the display device 1060.

The power supply 1050 may provide power for operations of the electronic device 1000.

The display device 1060 may be connected to other components through buses or other communication links.

The present disclosure may apply to any display device and any electronic device including the touch panel. For example, the present disclosure may apply to a mobile phone, a smart phone, a tablet computer, a digital television TV, a 3D TV, a personal computer PC, a home appliance, a laptop computer, a personal digital assistant PDA, a portable multimedia player PMP, a digital camera, a music player, a portable game console, a navigation device, etc.

The foregoing is illustrative of the inventive concept of the present disclosure and is not to be construed as limiting thereof. Although several embodiments of the present disclosure have been described, those skilled in the art will readily appreciate that many modifications are possible without materially departing from the novel teachings and advantages of the present disclosure. Accordingly, it will be understood that all such modifications are intended to be included within the scope of the present disclosure as defined in the claims. In the claims, means-plus-function clauses are intended to cover not only the structures described herein as performing the recited function but also structural equivalents thereof. It will be understood that the scope of the present disclosure is defined by the following claims, with equivalents of the claims to be included therein.

What is claimed is:

1. A display device, comprising:
a display panel including a plurality of compensation areas, each of the compensation areas including at least one pixel;
a driving controller including a compensation controller and a luminance color compensator, performing a luminance and color compensation for each of the compensation areas, and generating a voltage code and a data signal;
a gamma reference voltage generator receiving the voltage code and generating a gamma reference voltage based on the voltage code; and
a data driver connected to the driving controller and the gamma reference voltage generator, and generating a data voltage based on the data signal and the gamma reference voltage,
wherein each of the compensation areas after the luminance and color compensation has a target gamma value and a target color coordinate, and
wherein the compensation areas are shifted while the luminance color compensation is performed.

2. The display device of claim 1, wherein a luminance difference corresponding to a delta voltage code occurs at a compensation boundary when the luminance color compensation is performed.

3. The display device of claim 2, wherein the luminance difference corresponding to the delta voltage code becomes large when the delta voltage code is large.

4. The display device of claim 1, wherein the voltage code changes when the compensation areas are shifted while the luminance color compensation is performed.

5. The display device of claim 4, wherein a degree to which the voltage code changes varies depending on a shift degree of the compensation areas.

6. The display device of claim 5, wherein the voltage code changes gradually when the shift degree of the compensation areas is large.

7. The display device of claim 1, wherein the voltage code in an area between two adjacent compensation areas is sequentially changed by the delta voltage code.

8. The display device of claim 1, wherein a shift direction of the compensation areas is a left-right direction.

9. The display device of claim 1, wherein a shift direction of the compensation areas is an up-down direction.

10. The display device of claim 1, wherein a shift degree of the compensation areas varies depending on a resolution of the display panel.

11. The display device of claim 10, wherein the shift degree of the compensation areas becomes great when the resolution of the display panel is high.

12. A method of compensating for a luminance and a color of a display device, the method comprising:
performing a luminance and color compensation for each of a plurality of compensation areas included in a display panel;
generating a voltage code and a data signal;
generating a gamma reference voltage based on the voltage code; and
generating a data voltage based on the data signal and the gamma reference voltage,
wherein each of the compensation areas after the luminance and color compensation has a target gamma value and a target color coordinate, and
wherein the compensation areas are shifted while the luminance and color compensation is performed.

13. The method of claim 12, wherein a luminance difference corresponding to a delta voltage code occurs at a compensation boundary when the luminance color compensation is performed.

14. The method of claim 13, wherein the luminance difference corresponding to the delta voltage code becomes large when the delta voltage code is large.

15. The method of claim 12, wherein the voltage code changes when the compensation areas are shifted while the luminance color compensation is performed.

16. The method of claim 15, wherein a degree to which the voltage code changes varies depending on a shift degree of the compensation areas.

17. The method of claim 16, wherein the voltage code changes gradually when the shift degree of the compensation areas is large.

18. The method of claim 12, wherein the voltage code in an area between two adjacent compensation areas is sequentially changed by the delta voltage code.

19. The method of claim 12, wherein a shift direction of the compensation areas is a left-right direction.

20. An electronic device, comprising:
a display panel including a plurality of compensation areas, each of the compensation areas including at least one pixel;
a driving controller including a compensation controller and a luminance color compensator, performing a luminance and color compensation for the each of the compensation areas, and generating a voltage code and a data signal;
a processor configured to control the driving controller;
a gamma reference voltage generator receiving the voltage code and generating a gamma reference voltage based on the voltage code; and
a data driver connected to the driving controller and the gamma reference voltage generator, and generating a data voltage based on the data signal and the gamma reference voltage,
wherein each of the compensation areas after the luminance and color compensation has a target gamma value and a target color coordinate, and
wherein the compensation areas are shifted while the luminance color compensation is performed.
